(19) United States
(12) Patent Application Publication
(10) Pub. No.: US 2014/0367190 A1
(43) Pub. Date: Dec. 18, 2014

(54) Steering Mechanism

(71) Applicant: François Porcheron, Bruxelles (BE)

(72) Inventor: François Porcheron, Bruxelles (BE)

(73) Assignee: 4POWER4 SPRL, Bruxelles (BE)

(21) Appl. No.: 14/006,147

(22) PCT Filed: Mar. 21, 2011
(86) PCT No.: PCT/EP2011/054234

§ 371 Date: Nov. 19, 2013

(51) Int. Cl. A61G 5/10; B62D 5/04; B62D 7/08

(52) U.S. Cl. CPC A61G 5/10; B62D 7/08; B62D 5/0421; A61G 2005/1051
USPC 180/443; 280/93.508

(57) ABSTRACT

A steering mechanism comprising a first swing bar (1) with a first link (12) designed to allow the swing bar (1) to pivot about an axis of rotation (z). A second link (13) collaborates via a second pivot (23) with a first member (33) collaborating with a first wheel (43), and a third link (14) collaborates via a third pivot (24) with a second member (34) collaborating with a second wheel (44). The second link and the third link are positioned symmetrically. A fourth link (15) is designed to be able to collaborate via a fourth pivot (25) with a linear actuator (4). The fourth link is offset from said central axis so that actuation of the linear actuator (4) causes the swing bar to rotate, and causes a rotation of the wheels (43, 44).

### TECHNICAL FIELD

The present invention relates to a steering mechanism for directing the steered wheels of a vehicle with respect to the chassis. The present invention relates in particular to a steering mechanism intended for short vehicles and for which a reduced steering radius is required. The present invention also relates to a wheelchair for disabled people provided with such a steering mechanism.

### STATE OF THE ART

The most often used steering mechanism in vehicles with four wheels is known under the name of Ackermann steering. The Ackermann steering, which it is not necessary to describe here in more detail, allows the four wheels of the vehicle to be oriented towards the tangents of concentric circles. The steering radius is determined by the distance between the center of the circles and the wheels. The wheels thus turn around a same point, which makes it possible to preserve the tires, to guarantee an optimum adhesion and to reduce the noise.

The geometry of the Ackermann device is however not perfect and the centers of rotation of the four wheels are not perfectly superimposed. In addition, the steering radius depends on the length of the vehicle and especially on the distance between the front axle and the rear axle. Though very long vehicles, for example coaches, can perform sharp turns, the same does not apply to short vehicles.

Yet many short vehicles, notably wheelchairs for the disabled people or commercial vehicles such as small tractors, require a large maneuverability and a reduced steering radius in order to change the orientation of the vehicle practically on the spot, without excessive wear on the tires and with a minimum of noise.

U.S. Pat. No. 4,852,679 describes a steering with reduced steering radius for an electrical wheelchair. The mechanism uses cables to connect the four wheels to the center of the vehicle. The unit is fragile and the different cables require a substantial amount of space under the vehicle. This volume cannot be used for the batteries for example.

DE4236786 describes a steering for an electrical wheelchair that affords a very small steering radius thanks to a system of cams. The computing and machining of the cams are complex, and the wear and tear of the movable parts in the cams is rapid.

Another steering mechanism based on cams is described in U.S. Pat. No. 5,862,874.

WO08141676 describes a steering mechanism having linking rods and linear displacement axles, which is particularly well adapted for short vehicles and chairs for disabled people for example. However, the linking rods that slide along rectilinear slides connected to the chassis prove fragile and sensitive to sand or projections of earth.

Other wheelchairs are steered by accelerating the outside wheels in the turns, without orienting them correctly. These mechanisms are simple to make mechanically, but the electronics for the motor control are more complex. Furthermore, the badly oriented tires make a substantial noise in the turns and tend to wear rapidly by leaving marks.

### BRIEF SUMMARY OF THE INVENTION

An aim of the present invention is thus to propose an improved steering mechanism compared to the prior art mechanisms, and in particular a device adapted for short vehicles that does not have the above-mentioned disadvantages.

According to the invention, these aims are achieved by means of a steering mechanism according to the independent claim, with preferred variant embodiments being indicated in the dependent claims.

In particular, these aims are achieved by means of a steering mechanism having a first swing bar, said swing bar comprising:

a first link designed to allow the swim bar to pivot about an axis of rotation (z);

a second link designed to be able to collaborate via a second pivot with a first member collaborating with a first wheel connected to the steering mechanism;

a third link designed to be able to collaborate via a third pivot with a second member collaborating with a second wheel connected to the steering mechanism;

wherein the second link and the third link are positioned symmetrically in relation to the longitudinal axis of the steering mechanism when said wheels are straight;

a fourth link designed to be able to collaborate via a fourth pivot with a linear actuator, wherein the fourth link is offset from said central axis when the wheels are straight so that actuation of the linear actuator connected in pivoting manner to said swing bar causes the swing bar to rotate around said first link and said axis of rotation, and causes a rotation of said first and second wheels via the first and second members.

This steering mechanism has the advantage of having fewer parts than most prior art steering mechanisms. It is thus less expensive to produce and more robust.

This steering mechanism further has the advantage of using only rotating parts, with the exception of the linear actuator, whose translations are immediately converted to rotation by the swing bar. The rotation movements require less fragile parts than translation movements that require slides or bearings more likely to block.

This steering mechanism makes it possible to achieve in a very simple manner a rotation of the four wheels of the vehicle, with different or even opposite rotation angles depending on the curve radius of the vehicle.

Other advantages will emerge when reading the description illustrated by the attached figures.

### BRIEF DESCRIPTION OF THE DRAWINGS

Examples of embodiments of the invention are indicated in the description illustrated by the attached figures, wherein:

FIG. 1 illustrates a perspective view of a chassis of a vehicle, for example a motorized chair for disabled people, provided with a steering mechanism according to one embodiment of the invention.

FIG. 2 illustrates a perspective view of a swing bar according to the invention.

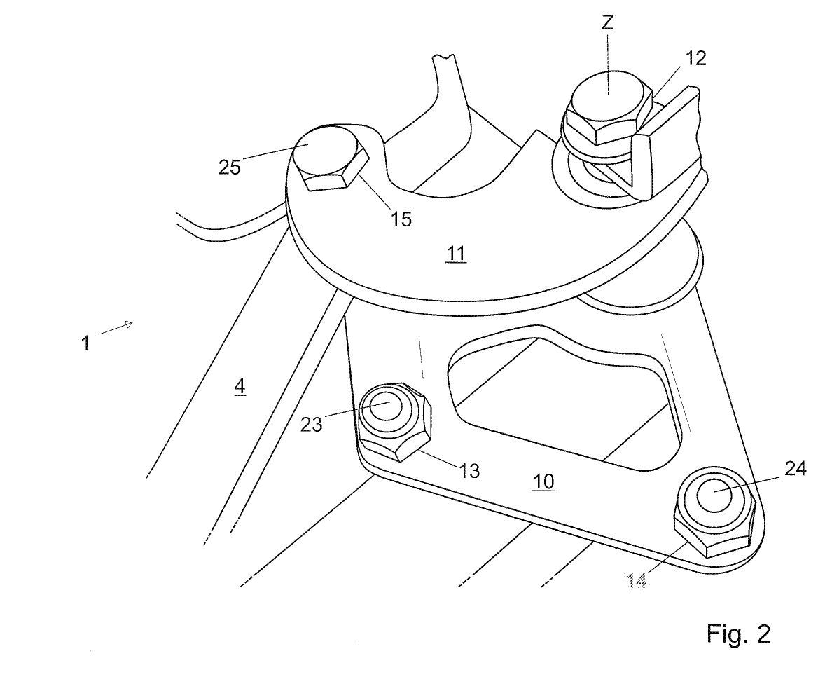

### EXAMPLE(S) OF EMBODIMENTS OF THE INVENTION

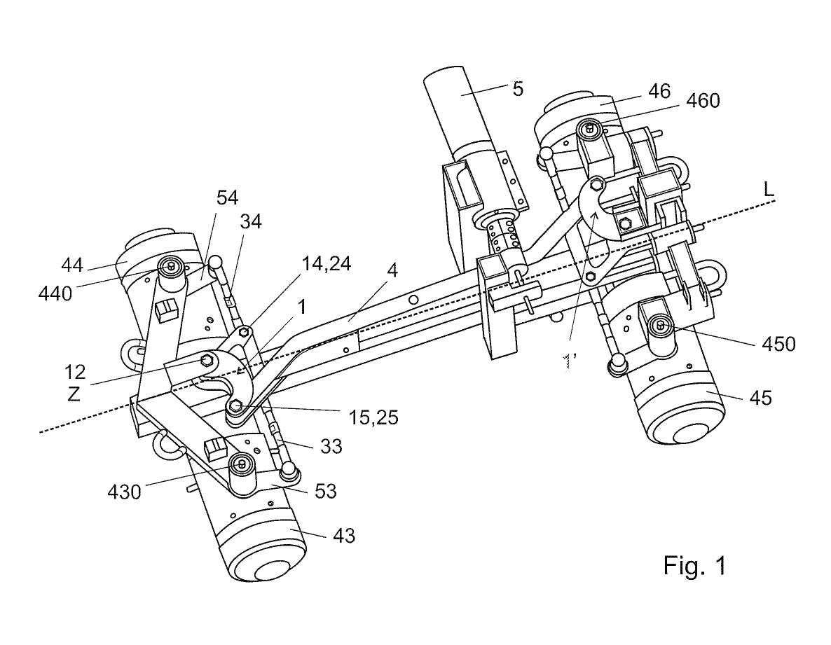

FIG. 1 illustrates a perspective view of the chassis of a short vehicle, for example of a motorized wheelchair, provided with a steering mechanism according to the invention. The mechanism described is however applicable to other types of vehicles, notably to any type of short vehicles requiring a reduced turning radius, including vehicles with two or four steered wheels and with two or four drive wheels. An example of vehicle to which this steering mechanism could be applied is described in WO08141676, the contents whereof are incorporated by reference.

One of the aims of this steering mechanism is to enable two or four wheels of the vehicle to turn simultaneously, along different angles of rotation inside and outside the curve, in order to enable the vehicle to negotiate tight turns. The rotations of the steering mechanism are achieved by actuating electronically a servomotor 5 whose rotations cause a linear displacement of the linear actuator 4, so as to cause then the four wheels 43 to 46 to turn simultaneously. The angular position of the servomotor 5, and thus the angle of rotation of the wheels, is controlled by applying the desired voltage at the control input of the servomotor, for example by means of a potentiometer (not represented). Advantageously, the wheels take up the same position when the input voltage applied to the servomotor 5 is the same. For example, the wheels return to the straight position when the input voltage applied to the servomotor is zero.

The four wheels are drive wheels and are driven each by an independent electric motor. The motors are powered electrically by means of batteries advantageously located on both sides of the linear actuator 4. Control electronics, not represented, make it possible to control independently the speed of the four wheels 43 to 46 according to the instructions entered using a joystick for example. It is possible to control electronically the rotation speed of the wheels in an independent fashion, so that the wheels on the outside of a curve turn faster than those on the inside. As can be seen in particular in FIG. 1, the electric motors are mounted on the rotation axis of the wheels and thus turn with the wheel in the turns. This makes it possible to avoid articulated links between the shaft of the motors and that of the wheels. In a preferred embodiment, the electronic control of the motors makes it possible to assign to the outside wheels a speed greater than the speed of the inside wheels in the turns.

In one embodiment, the wheels are driven by means of a single central motor. It is of course also possible to drive only the front wheels or the rear wheels.

The wheels 43 to 46 can turn relative to the chassis, constituted notably of transversal cross-pieces 3 and of the longitudinal cross-piece 4, around the first vertical spindles 430, 440, 450, 460 respectively, so as to change the direction of the vehicle. The movements of the four wheels are linked mechanically to one another, so that the rotation of one wheel necessarily causes the orientation of the other three wheels to be modified. The wheels are only parallel to one another when they are straight; as soon as they turn, the inside wheels pivot more than the outside wheels, and the front wheels pivot in the opposite direction to that of the rear wheels. The steering mechanism with the two swing bars 1, 1′ of the invention enables these rotations to be controlled.

At the rear of the vehicle, for example, the swing bar 1 comprises a first link 12 designed to allow the swing bar to pivot about a vertical axis of rotation z relative to the chassis, as soon as the user wishes to turn. A second link 13 is designed to be able to collaborate via a second pivot 23 with a first member 33 collaborating with a first wheel 43 of the vehicle to make it pivot around the axle 430. The first member 33 in this example is constituted by a longitudinal bar that is connected in a pivoting manner to a first element 53, for example a rod or a plate integrally united with the first wheel 43.

In a symmetrical manner relative to the longitudinal axis L of the vehicle, a third link 14 is designed to be able to collaborate via a third pivot 24 with a second member 34 collaborating with a second wheel 44 of the vehicle to make it pivot around the axle 440. The second member 34 is for example constituted by a longitudinal rod that is connected in pivoting manner to a second element 54, for example a rod or a plate integrally united with the second wheel 44.

The second link 13 and the third link 14 are arranged on a first part 10 of the swing bar. This first part is constituted here of a plate that is hollowed out to make it lighter and to make the rotations of the steering column easier and quicker.

The swing bar comprises a second part 11 constituted by another plate in a plane different from the first plane 10. This arrangement notably allows the linear actuator 4 to pivot above the first plate 10 without touching it and allows the first and second members 33 and 34 to pivot relative to the swing bar without touching either the second plate or the linear actuator 4. In other words, the design of the links in two planes enables collisions between the linear actuator 4 and the two members 33, 34 during rotations to be avoided. In the illustrated example, the second part 11 is in the shape of a “C” or of an inverted “C” so as to reduce its weight.

The second plate 11 is connected to the first plate 10 by means of an intermediary part 16, in this example a hollow cylindrical tube. The first link 12 between the swing bar and the chassis goes through this intermediary part. The second and third links 13 and 14 are placed symmetrically around the first link, on either side of the longitudinal axis L.

The second plate comprises a fourth link 15 designed to be able to collaborate via a fourth pivot 25 with a linear actuator 4 connected in a pivoting fashion relative to the swing bar. The linear actuator follows approximately the longitudinal axis L at the center of the vehicle and is constituted by a rectilinear tube whose two extremities are folded back in opposite directions.

The fourth link 15 is offset from said central axis when the wheels are straight, so that the longitudinal displacement of the linear actuator 4, which is connected in pivoting manner to the swing bar 1, causes the latter to rotate around the first link 12 and axis of rotation z. This rotation is transmitted via the first member and first element 33, 53 and second member and second element 34, 54 respectively to the first and second wheels 43,44 respectively.

The linear actuator 4 can be controlled so as to be displaced linearly along the longitudinal axis L by means of a servomotor 5 mounted in a horizontal plane, perpendicularly to the axis L. The controlled rotations of the servomotor 5 are transformed into translations of the linear actuator 4 by means of a shaft or a cam, not represented. The angular position of the servomotor 5 is controlled by means of a control voltage applied to the servomotor, this control voltage thus enabling the orientation of the four wheels of the vehicle to be controlled. In an advantageous embodiment, the control voltage determining the angular position of the servomotor 5, and thus that of each wheel, is determined by means of a potentiometer actuated by the vehicle's user.

The servomotor thus returns to its initial position when the potentiometer supplies a predefined voltage, for example at 0V.

As seen in FIG. 1, the vehicle comprises a second swing bar 1′ at the opposite longitudinal end of the vehicle, in order to control the other two wheels 45 and 46 and to make them pivot in opposite direction to the first and second wheels 43, 44. The other elements connected to the second swing bar are identical or simply symmetrical to the corresponding elements connected to the first swing bar, and their description shall thus not be repeated here. The two swing bars at the front and at the back of the vehicle are thus in a mirror arrangement, so that actuating the linear actuator to cause the first swing bar to rotate in clockwise direction causes the second swing bar to rotate anticlockwise and vice-versa.

### LIST OF THE REFERENCE NUMBERS USED IN THE FIGURES

1 swing bar

1′ second swing bar

10 first part of the swing bar

11 second part of the swing bar

4 linear actuator

5 servomotor

12 first link

13 second link

14 third link

15 fourth link

16 intermediary element

23 second pivot

24 third pivot

25 fourth pivot

33 first member

34 second member

43 first wheel

44 second wheel

45 third wheel

46 fourth wheel

53 first element

54 second element

Z axis of rotation

L longitudinal axis

What is claimed is:

1-12. (canceled)

13. Steering mechanism for orienting wheels of a vehicle, said mechanism having a first swing bar, said swing bar being actuated by a linear actuator, said swing bar comprising:
a first link connected to the chassis of said steering mechanism in order to enable said swing bar to pivot about an axis of rotation in relation to said chassis when said linear actuator is actuated;
a second link designed to be able to collaborate via a second pivot with a first member collaborating with a first wheel connected to the steering mechanism;
a third link designed to be able to collaborate via a third pivot with a second member collaborating with a second wheel connected to the steering mechanism;
wherein the second link and the third link are positioned symmetrically in relation to the longitudinal axis of the chassis;
a fourth link designed to be able to collaborate via a fourth pivot with said linear actuator, wherein the fourth link is offset from said central axis when the wheels are straight so that actuation of the linear actuator connected in a pivoting manner to said swing bar causes the swing bar to rotate around said first link and said axis of rotation, and causes a rotation of said first and second wheels via the first and second members,
said swing bar further comprising:
a first part that comprises the second and third links;
a second part that comprises the second and third links;
wherein the first part and the second part are in two different planes.

14. The steering mechanism of claim 13, wherein the first member is connected in pivoting fashion to a first element collaborating with the first wheel to make it pivot, and wherein the second member is connected in pivoting fashion to a second element collaborating with the second wheel to make it pivot when the swing bar pivots about said axis of rotation.

15. The steering mechanism of claim 13, wherein the second part is connected to the first part by means of an intermediary part, wherein said first link goes through said intermediary part.

16. The steering mechanism of claim 13, wherein said first part is hollowed out in order to reduce its weight.

17. The steering mechanism of claim 13, wherein said second part has the shape of a “C”.

18. The steering mechanism of claim 13, comprising a rotating servomotor collaborating with said linear actuator to cause an axial displacement of said linear actuator in order to produce a rotation of the swing bar.

19. The steering mechanism of claim 18, comprising a potentiometer to control said rotating servomotor.

20. The steering mechanism of claim 19, wherein said servomotor returns to its initial position when the potentiometer supplies a predefined voltage.

21. The steering mechanism of claim 13, comprising a second swing bar connected to an end of the linear actuator so as to cause a third and a fourth wheel to rotate when said linear actuator is actuated.

22. The steering mechanism of claim 21, wherein said second swing bar is arranged in a mirror layout to said first swing bar so that actuating the linear actuator to cause the first swing bar to rotate in clockwise direction causes the second swing bar to rotate anticlockwise and vice-versa.
